(19) United States
(12) Patent Application Publication
(10) Pub. No.: US 2008/0259867 A1
(43) Pub. Date: Oct. 23, 2008

(54) METHOD AND SYSTEM FOR SCHEDULING PACKETS FROM DIFFERENT FLOWS TO PROVIDE FAIR BANDWIDTH SHARING

(76) Inventor: Chuanxiong Guo, Nanjing (CN)

Correspondence Address: Chuanxiong Guo, Room 304, Building 1, No. 1-58 Ruijin Road, Nanjing, 210002, CN

(21) Appl. No.: 11/738,512

(22) Filed: Apr. 22, 2007

(51) Int. Cl. H04Q 7/00

(52) U.S. Cl. 370/330

(57) ABSTRACT

A method and system for scheduling packets to provide fair bandwidth sharing is provided. A packet scheduling system is composed of a communication link and flows from different network applications. These flows share the same communication link and have different bandwidth reservation according to different application requirements. In this invention, the bandwidth of the communication link is expressed into its binary form, and the binary coefficients are used to form a Square Weight Matrix. Moreover, each non-zero binary coefficient is expressed by a Weighted Binary Tree. The Square Weight Matrix is further spread by a Weight Spread Sequence and each Weighted Binary Tree is spread into a Time-Slot Array by using a Binary Reversal operation. When a flow is accepted by the scheduling system, the system first expresses the requested bandwidth of the flow into binary form, and then for each non-zero coefficients, the system allocates a node with the same weight from the Weighted Binary Trees to the flow. Accordingly, when a flow leaves the system, the Weighted Binary Trees nodes that have been allocated to the flow are de-allocated, and the corresponding terms of the TArrays are reset. The scheduling system schedules packets by sequentially scanning the Weight Spread Sequence. For a specific value of the scanned Weight Spread Sequence term, a corresponding TArray is then selected, and the flow that occupies the current term of the TArray is then chosen and served.

### TECHNICAL FIELD

The described technology relates generally to packet scheduling of a communication link with flows that have different bandwidth requirements.

### BACKGROUND

Although the Internet has had great successes in facilitating communications between computer systems and enabling many important networked applications such as Web browsing, email, video streaming, and voice over IP, etc., the basic service provided by the Internet is a “best effort” service. “Best effort” means that the routers in the network try their best to transmit packets, but do not provide any guarantee on when the packet will arrive at its destination, or whether a packet will be delivered, or how much bandwidth an application can get.

Different applications, however, have different characteristics, and therefore different requirements for the network. For example, voice-over-IP applications require that the voice packets can be delivered to their destinations within a bounded delay; video stream applications require that the Internet to provide guaranteed bandwidth; and video conferencing applications needs both guaranteed bandwidth and bounded delay guarantees.

It is therefore natural to enhance the “best-effort” Internet to provide differentiated services to applications with different requirements. One of the key technologies to enable service differentiation is a packet scheduler. In a packet scheduler, packets from different applications are queued into different queues. The packet scheduler decides which queue to serve once it finishes transmitting the previous packet. To provide bandwidth and delay guarantee, Fair Queueing packet schedulers were proposed. Fair Queueing schedulers provide different bandwidth to different queues based on the bandwidth reservations from different applications, and split the surplus bandwidth to all the applications in proportion to their reserved bandwidth.

Since a packet scheduler must be invoked for every packet transmitted in a network device such as router or switch, it is therefore a critical part for any routers or bridges to provide service differentiation. Generally, we expect that a packet scheduler should: 1. provide fair bandwidth sharing among competing applications; 2. provide end-to-end delay guarantees so that packets can reach their destination in bounded time; 3. have low time-complexity and simple to implement since the scheduling action needs to be invoked for every packet. Low-time complexity is especially important for high-speed network devices, since these devices must process tens of millions packets every second.

Due to their ability to provide fair bandwidth sharing, Fair Queueing schemes have been studied extensively. Many Fair Queueing algorithms such as WFQ, WF²Q, DRR, SRR, have been proposed. WFQ and its variants can provide bounded end-to-end delay as well as fair bandwidth sharing. Their time-complexity, however, is as least O(logN), where N is the number of flows in the scheduler. For high-speed routers, which need to handle tens of millions flows simultaneously, logN, however, is still a large number. For example, when N=10⁷, log₂N is approximately 23. WFQ and its variants, therefore, are not scalable for high-speed network devices.

DRR and its variants are simple packet schedulers and generally have O(1) time-complexity, and share the bandwidth of the communication link fairly among competing flows according to their reserved bandwidth. However, these round-robin schedulers generally cannot provide bounded end-to-end delay, and therefore are not appropriate for real-time applications where bounded delay is a mandatory requirement.

It is therefore highly desirable to find a method that has all the desired properties: O(1) time-complexity, fair bandwidth sharing, and bounded end-to-end delay. In this invention, we describe a new packet scheduling method and system that achieves all these three properties.

### SUMMARY

A method and system for scheduling packets to provide fair bandwidth sharing among competing flows with different bandwidth requirements is provided. In one embodiment, the binary coded bandwidth of the communication link is expressed as a Square Weight Matrix, and the bandwidth represented by each non-zero term of the Square Weight Matrix is further expressed by a Weighted Binary Tree. For each non-zero binary coefficient of the reserved rate of an incoming flow, the scheduling system allocates a node with the same weight from the Weighted Binary Trees. The scheduling system also associates a specially designed Weight Spread Sequence with the Square Weight Matrix, and a Time-Slot Array with each Weighted Binary Tree. Each node in the Weighted Binary Trees corresponds to a set of Time-Slot Array terms, the indices of the terms are decided by using a Binary Reversal operation, and the terms contains the id of the flow that owns the Weighted Binary Tree node. The scheduling system then uses the Weight Spread Sequence to scan the Square Weight Matrix circularly. When a non-zero term of the Square Weight Matrix is met, the corresponding Weighted Binary Tree is selected. The current term of the corresponding Time-Slot Array is then selected, and the flow that occupies this Time-Slot Array term is chosen and served.

### BRIEF DESCRIPTION OF THE DRAWINGS

FIG. 1 is a block diagram that illustrates how the nodes of a Weighted Binary Tree are allocated and freed.

FIG. 2 is a block diagram that illustrates the initial status of the lists that contain the free Weighted Binary Tree nodes.

FIG. 3 is a block diagram that illustrates the status of the lists that contain the free Weighted Binary Tree nodes after flows are added into the system.

FIG. 4 is a block diagram that illustrates the construction of the Weighted Binary Trees and the Time-slot Arrays (TArrays) when flows are added into the system.

FIG. 5 is a block diagram that illustrates the implementation structure of the packet scheduling system.

### DETAILED DESCRIPTION

A method and system for scheduling packets at a network device, such as the network interface of a router, a server computer, or an end-host computer. In the network device, there exits many flows with different reserved rates that share the same output communication link. In one embodiment, a scheduling system provides a queue for each flow to buffer the incoming packets. There are three procedures in the system: a flow_add procedure to add a new flow into the scheduling system; a flow_delete procedure to remove an old flow from the system; and a schedule procedure to decide which flow to serve when the network interface finishes serving the previous flow. When a new flow with a rate request arrives, if its requested rate is no more than the surplus capacity of the output link, the scheduling system invokes the flow_add procedure to accept the new flow into the system. When the system decides that a flow is to be removed, it then invokes the flow_delete procedure to remove the flow from the system. When a packet of an accepted flow arrives at the system, it will be queued into the queue that corresponds to the flow. Whenever there are packets in the queues, the system uses the schedule procedure to decide which flow to serve. The schedule procedure is invoked for each packet when the previous packet has been transmitted by the output link.

In one embodiment, the scheduling system contains several data structures: a Square Weight Matrix (SWM), a Weight Spread Sequence (WSS), several Weighted Binary Trees (WBTs), and a Time-slot Array (TArray) for each Weighted Binary Tree.

The Square Weight Matrix is generated based on the bandwidth of the output link. The number of columns (and rows) of a Square Weight Matrix is k, where k=└log₂ C┘+1, C is the bandwidth of the output link. The diagonal term at column i and row i of the Square Weight Matrix, aᵢ (0≦i<k) for abbreviation, is the ith binary coefficient of the bandwidth C, that is C=Σ^{k-1}ᵢ₌₀aᵢ2ⁱ. The rest terms of the Square Weight Matrix are zero. For example, when the output bandwidth C=13, a₃=a₂=a₀=1 and a₁=0.

The Square Weight Matrix is then associated with a specially designed Weight Spread Sequence (WSS) of order k. The WSS sequence of order 1 is defined to have only one term 1. That is, WSS1={1}. An nth WSS has 2ⁿ−1 terms, and is composed from two (n−1)th WSS and a term n, WSSⁿ={WSSⁿ⁻¹, n, WSSⁿ⁻¹}. From this definition, we get that WSS²={WSS¹, 2, WSS¹}={1, 2, 1}, WSS³={WSS², 3, WSS²}={1,2,1,3,1,2,1}, WSS⁴={WSS³, 4, WSS³}={1,2,1,3,1,2,1,4,1,2,1,3,1,2,1}. For a specific k times k Square Weight Matrix, the scheduling system pre-generates and stores a kth WSS sequence in the system.

In the packet scheduling system, we further use Weighted Binary Trees (WBT) to track the usage of the whole bandwidth of the output link. For a non-zero term in the Square Weight Matrix in column n, there exists a Weighted Binary Tree of weight 2ⁿ. A Weighted Binary Tree therefore represents part of the bandwidth of the output link.

A node in the Weighted Binary Tree may have a parent, a left child, a right child, and a sibling. The root of tree does not have a parent and the leaves do not have children. A node also has several attributes, a weight attribute that represents the weight of the tree, a level attribute that represents the level of the node in the tree, an index attribute to denote the id of the node in that level of the tree, a flow id attribute to indicate to which flow this node belongs. The weight attribute is denoted as node.w, where 2^{node.w} is the weight of the tree. The level attribute is denoted as node.h. The root of a tree has level 0, and the children of the root have level 1, the grandchildren of the root have level 2, and so on. The index of a node in level h has value ranged from 0 to 2^{h}−1 (inclusive). The indices of the nodes from left to right in the same level are numbered from 0 to 2^{h}−1. The left most node at level h has index 0, and the right most node has index 2^{h}−1. A node is denoted as V^{w}(h, i), where w represents the weight of the tree, h represents the level of the node, and i represents the index of the node in level h.

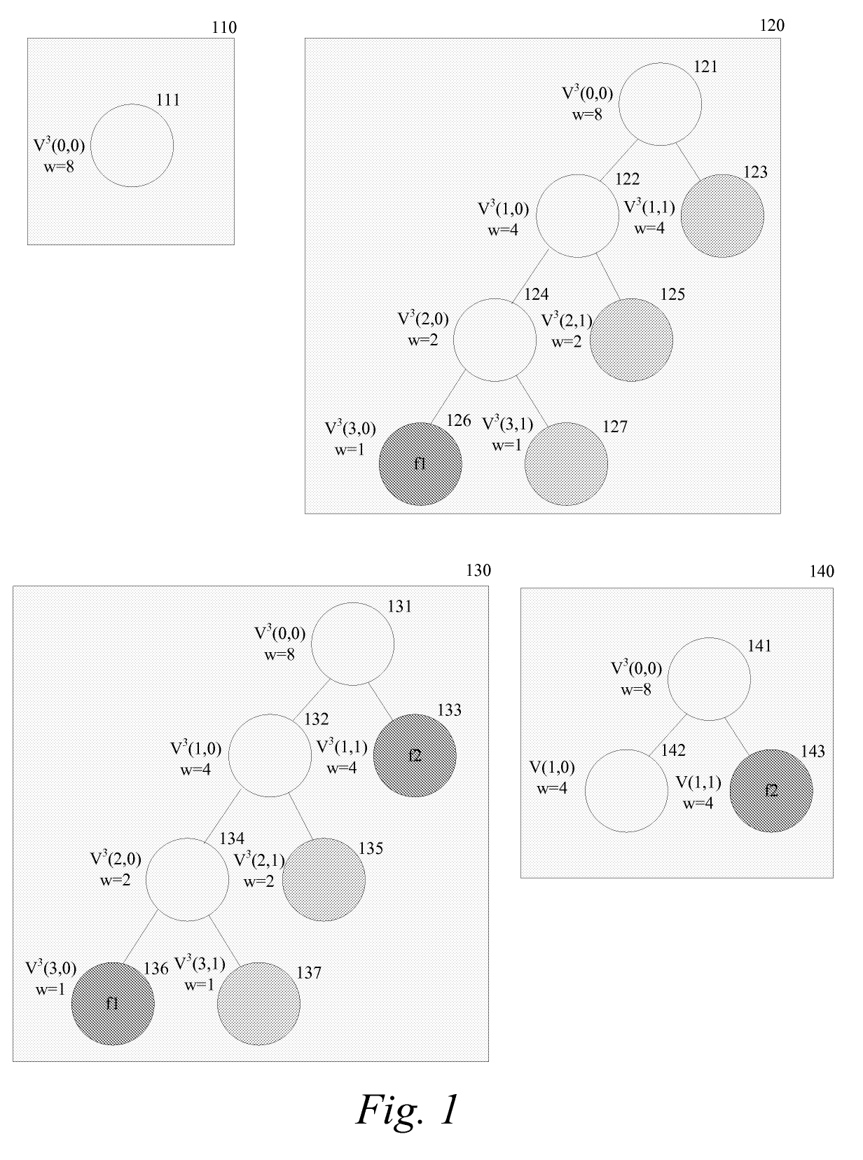

The shape of a Weighted Binary Tree evolves dynamically when flows join and leave. FIG. 1 shows how a Weighted Binary Tree with weight 8 evolves. At first, the bandwidths of this Weighted Binary Tree are not allocated, and therefore the tree 110 has only one node V³(0,0) 111 in the tree. V³(0,0) 111 has all the weights of the tree. The tree 120 shows the shape of tree when a flow f1 with rate 1 is accepted. Since the required rate is smaller than the weight of the root node V³(0,0) 121, V³(0,0) 121 is split into two child nodes V³(1,0) 122 and V³(1,1) 123, each with weight 4. Since the weights of these two nodes are still larger than the required rate 1, the system then choose V³(1,0) 122, the left child of V³(0,0) 121, and splits V³(1,0) 122 into two nodes V³(2,0) 124 and V³(2,1) 125 with weight 2. Similarly, the system then chooses V³(2,0) 124 and splits it into V³(3,0) 126 and V³(3,1) 127. Since the weights of V³(3,0) 126 and V³(3,1) 127 matches the rate of f1, V³(3,0) 126 is then allocated to f1. The tree 130 shows the shape of the Weighted Binary Tree after a new flow f2 with rate 4 has been added. In this case, since node V³(1,1) 133 has weight 4 and is unallocated, it is then assigned to f2. From the above description, we see that a node V^{w}(h, i) in a Weighted Binary Tree has weight 2^{(w-h)}.

When a flow leaves the system, the shape of the tree also needs to be adjusted. The tree 140 shows the tree after flow f1 has left the system. When f1 leaves, node V³(3,0) 136 is then freed. Since in this case, both V³(3,0) 136 and V³(3,1) 137 are free, they are then both removed and their weights are represented by their parent node V³(2,0) 134. Similarly, since both V³(2,0) 134 and V³(2,1) 135 are not allocated, they are both removed and their weights are represented by V³(1,0) 132. The merge operation stops here, since V³(1,1) 133, the sibling node of V³(1,0) 132 is not free. The shape of the tree after f1 is removed is shown in Tree 140.

In the scheduling system, each Weighted Binary Tree is associated with an array, which is called Time-Slot Array (TArray). The TArray that associates with a Weighted Binary Tree with weight 2ⁿ has 2ⁿ terms. These terms are numbered from 0 to 2ⁿ−1 (inclusive). We denote the ith (0≦i<2ⁿ) term of the TArray as TArray[i]. In the beginning, the 2ⁿ terms are all initialized to zero, which means the whole bandwidth represented by the Weighted Binary Tree is unallocated. When a node Vⁿ(h, i) is allocated to a flow f in a Weighted Binary Tree of weight 2ⁿ, there are 2^{(n-h)} terms in the TArray that are allocated to f. The indices of these TArray terms that corresponds to node Vⁿ(h,i) form a Binary Reversal Set (BRS), which is denoted as RBS(Vⁿ(h,i))={binary_reversal(n,j)|i×2^{n-h}≦j<i×2^{n-h}+2^{n-h}}. binary_reversal(n,j) operates as follows. We first express j in its binary form using n bits, j=bₙ₋₁bₙ₋₂ . . . b₁b₀, where bᵢ(0≦i<n) has value 0 or 1. Then binary_resersal(n,j)=b₀b₁ . . . bₙ₋₂bₙ₋₁. For each element m in RBS(Vⁿ(h,i)), the value of TArray[m] is set to TArray[m]=f. As to FIG. 1, the Binary Reversal Set of node V³(2,1) 135 can be generated as follows. RBS(V³(2,1))={binary_reversal(3,j)|2≦j<4}={010b, 110b }={2,6}. Similarly, we can generate the RBS set of V³(1,1), RBS(V³(1,1))={1,3,5,7}.

The scheduling system maintains a set of lists to track the unallocated nodes in the Weighted Binary Trees. For an output link with bandwidth C, the number of links is k=└log₂C┘+1. The k lists are denoted as list[0], list[1], . . . ,list[k−1]. The unallocated node with weight 2ⁱ is put in list[i]. When the system needs to allocate a node with weight 2ⁱ to a flow, it only needs to look at links whose indices are no less than i.

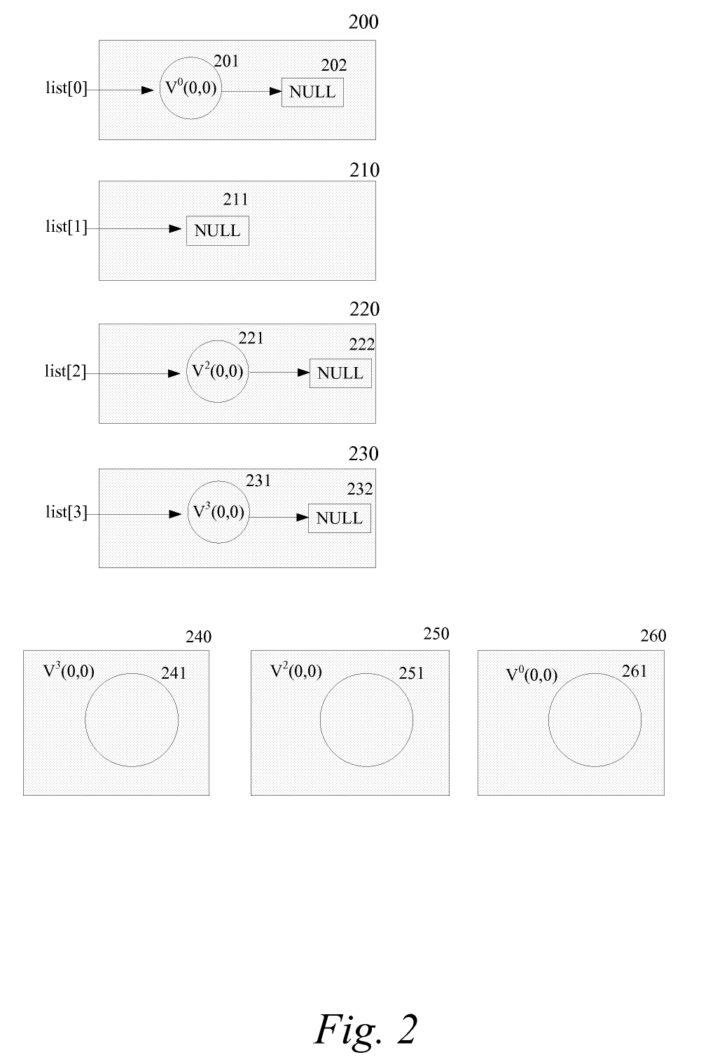

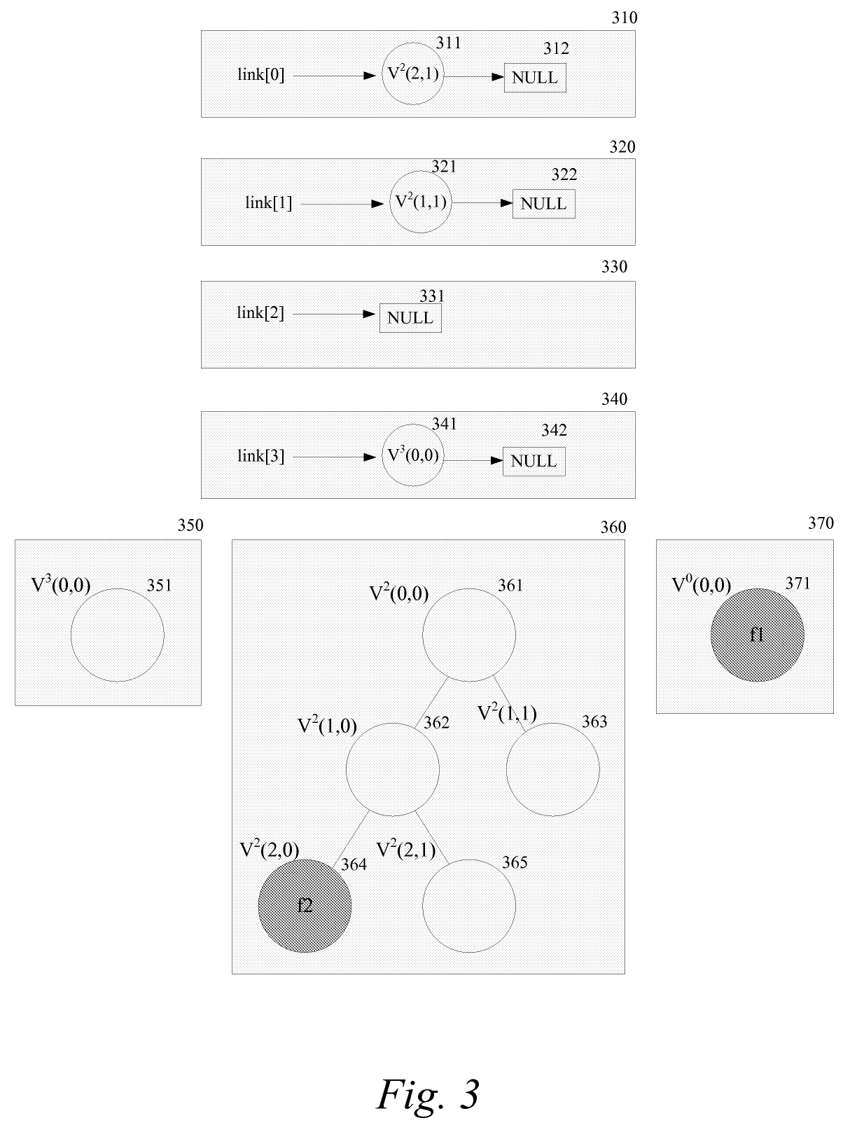

FIG. 2 shows the status of the links at the beginning for an output link with C=13. The Weighted Binary Trees 240, 250, and 260 are corresponds to the non-zero terms of the Square Weight Matrix a₃, a₂, and a₀, respectively. list[1] 210 is an empty list, since the term a₁ of the Square Weight Matrix is zero. The other three links list[0] 200, list[2] 220, and list[3] 230 have one node that represents the root node of the corresponding Weighted Binary Tree. When a flow f1 with rate 1 comes, the system starts to search the lists from list[0] 200. And since list[0] 200 has one node V⁰(0,0) 201, V⁰(0,0) 201 is then removed from list[0] 200 and allocated to f1. When flow f2 with reserved rate 1 arrives, the system also starts to look for a free node from list[0] 200. Since both list[0] 200 and list[1] 210 are now empty, the free node V²(0,0) 221 at list[2] 220 is used. And since the weight of V²(0,0) 221 is 4, which is larger than the required rate 1, the split operation is performed as depicted in tree 360 of FIG. 3. After that, V²(2,0) 364 is allocated to f2. And during the split operation, the free nodes V²(1,1) 363 and V²(2,1) 365 are put into link[1] and link[0], respectively. And since V²(0,0) has been partially used, it is removed from link[2] 330, and link[2] 330 becomes empty. FIG. 3 shows the Weighted Binary Trees and the status of the lists after f1 and f2 have been added into the Weighted Binary Trees.

TABLE 1 shows the pseudo code (using the C programming language) for allocating a node of weight 2w from the Weighted Binary Trees. AllocNode searches the lists from list[w] to list[k−1] for an unallocated node (lines 2-5). If no node is found, AllocNode fails and return NULL (lines 6 and 7). If the weight of the node equals the required weight, AllocNode returns the node directly (lines 8 and 9). If the weight of the node is larger than the required weight, the node is then split into a left child and right child, each with half of its weight. The right child is put to the appropriate list, and the left child is recursively split until its weight equals the required weight (lines 10-15). After that, the left child is returned.

TABLE 1

| Procedure to allocate a node with weight 2^{w} | |
|---|---|
| AllocNode(int w) { | |
| 1 | node=NULL; |
| 2 | for (j=w; j<k; j++) { |
| 3 | if (link[j] is not empty) |
| 4 | node=deque(list[j]); break; |
| 5 | } |
| 6 | if (node==NULL) |
| 7 | return NULL; |
| 8 | if (node.n − node.h == w) |
| 9 | return node; |
| 10 | while (node.n−node.h>w) |
| 11 | { |
| 12 | left_node = left_child(node); |
| 13 | right_node = right_child(node); |
| 14 | list[right_node.n−right_node.h].append(right_node); |
| 15 | } |
| 16 | return left_node; |
| } | |

TABLE 2 shows the pseudo C code for releasing an allocated node. FreeNode fist gets the sibling node (line 3). If the sibling node is unallocated, then the sibling node is in a list that contains free nodes. The index of the list is calculated in line 5, and then the sibling node is removed from the list (line 6). After that, the node and its sibling are deleted (line 7), and the node is changed to its father node (line 8). The operation is looped back using this father node. If the sibling node is not free (line 10), FreeNode needs to put the node into the right list. It first gets the index of the list (line 11), appends the node into the list (line 12), and then breaks the loop and returns (line 13).

TABLE 2
Procedure to release a node
FreeNode(node) {

| | |
|---|---|
| 1 | while(TRUE) |
| 2 | { |
| 3 | sibling_node = get_sibling(node); |
| 4 | if (slibling_node is free) { |
| 5 | index = node.n − node.h; tmp_node=father_node(node); |
| 6 | list[index].remove(sibling_node); |
| 7 | delete node; delete sibling_node; |
| 8 | node = tmp_node; |
| 9 | } |
| 10 | else{ |
| 11 | index = node.n − node.h; |
| 12 | list[index].append(node); |
| 13 | break; |
| 14 | } |
| 15 | } |
| } | |

TABLE 3 shows the pseudo C code for updating the TArray items that corresponds to a node of a Weighted Binary Tree. UpdateTArray first gets the weight of the Weighted Binary Tree that the node belongs to (line 1), gets the level of the node (line 2), and the index of the node (line 3). UpdateTArray then calculates the index of the first term in TArray that belongs to the node using the binary_reversal operation (line 4). It then updates the 2^{(n-h)} terms of the TArray sequentially (lines 5-8).

TABLE 3
Procedure to update the TArray terms of a Weighted Binary Tree node
UpdateTArray(node, fid) {

| | |
|---|---|
| 1 | n = node.n; |
| 2 | h = node.h; |
| 3 | i = node.i; |
| 4 | ri = binary_reversal(n, i*2^{(n-h)}); |
| 5 | for (int j=0;j<2^{(n-h)};j++) { |
| 6 | index = (ri + j* 2^{h}) % 2ⁿ; |
| 7 | TArray[node.n][index]=fid; |
| 8 | } |
| } | |

When a flow with reserved rate r comes, the scheduling system checks if C−allocated_bandwidth>=r. The allocated_bandwidth is the sum of the reserved rates of all the accepted flows in the scheduling system. If C−allocated_bandwidth <r, the system cannot accept the flow and the flow is rejected. If C−allocated_bandwidth>=r, the scheduling system calls flow_add as depicted in TABLE 4 to allocate nodes of the Weighted Binary Trees to the flow and update relevant terms of the corresponding TArrays. In flow_add, the rate of the accepted flow is checked from bit 0 to bit (k-1) (line 3). If the ith bit is not zero, flow_add then tries to allocate a node with weight 2ⁱ to the flow (line 6). If, however, flow_add cannot allocate a node with weight 2ⁱ (line 7), it then releases the previously allocated nodes that stored in the node_list and returns a FALSE to indicate the failure (lines 8-12). If flow_add does get a node with weight 2ⁱ, it then updates the terms of the corresponding TArray using UpdateTArray (line 14). Line 15 updates the allocated rates and line 16 adds the allocated node into the node_list. Line 17 checks if all the non-zero bits have been processed. Line 20 left shift the mask for 1 bit, so that the next bit of r can be checked. After all the non-zero bits of r have been processed, flow_add returns TRUE to indicate success.

TABLE 4

| Procedure to add a new flow into the packet scheduling system | |
|---|---|
| flow_add(r, fid) { | |
| 1 | int mask=1, assigned = 0; |
| 2 | list node_list; |
| 3 | for(i=0;i<k; i++) |
| 4 | { |
| 5 | if((mask & r) !=0) { |
| 6 | node = AllocNode(i); |
| 7 | if (node == NULL) { |
| 8 | for (each tmp_node in node_list) { |
| 9 | UpNodeTArray(tmp_node, 0); |
| 10 | FreeNode(tmp_node); |
| 11 | } |
| 12 | return FALSE; |
| 13 | } |
| 14 | UpdateTArray(node, fid); |
| 15 | assigned += mask & r; |
| 16 | node_list.append(node); |
| 17 | if (assigned == r) |
| 18 | break; |
| 19 | } |
| 20 | mask <<1; |
| 21 | } |
| 22 | return TRUE; |
| } | |

When a flow with id fid leaves, the scheduling system calls flow_delete as depicted in TABLE 5 to remove the flow from the system. flow_delete works as follows. For each node that is allocated to fid (recall that the nodes are stored in a node_list in TABLE 4), flow_delete first calls UpdateTArray to reset value of the terms that corresponds to the node to 0, then calls FreeNode to free that node.

TABLE 5

| Procedure to remove a flow | |
|---|---|
| flow_delete(fid) { | |
| 1 | for (each node allocated to fid) { |
| 2 | UpdateTArray(node, 0); |
| 3 | FreeNode(node); |
| 4 | } |
| } | |

The schedule process as depicted in TABLE 6 is the central part of the scheduling system. It decides which flow to serve when the previous flow has been served. The schedule process never ends. In the scheduling system, there is a pointer pw for the Weight Spread Sequence, and there is a pointer p[i] for each TArray[i]. In the beginning, schedule sets the pointer pw of the Weight Spread Sequence and the pointers of the TArrays to 0 (lines 2-3). Whenever there are packets in the queues (line 4), schedule gets the term index of the Square Weight Matrix by scanning the current term of the Weight Spread Sequence (line 5). The index is k minus the current term of WSS. If the term indexed is not zero (line 6), then the flow id f is gotten by scanned the corresponding TArray (line 7). If the flow f is backlogged (i.e., f has packets queued in the system), the flow is then served. Otherwise, idle_sched is called to distribute this opportunity to other flows. After that, the pointer that points to the TArray is incremented by one-step (line 11), and the pointer pw that points to the WSS is incremented by one-step (line 13). Note that in both the TArrays and WSS sequences, the first term is considered the next term of the last term. When there is no packet in the queues, the while loop in line 4 will be broken, and the pointers of the WSS sequence and TArrays are all reset (lines 2-3).

TABLE 6

| Procedure to decide which flow to serve | |
|---|---|
| Schedule( ) { | |
| 1 | while(1) { |
| 2 | pw=0; |
| 3 | for (int i=0; i<k; i++) p[i]=0; |
| 4 | while( there are packets in queues) { |
| 5 | i = k − WSS^{k}[pw]; |
| 6 | if (a[i]==1){ |
| 7 | f = TArray[i][p[i]]; |
| 8 | if (f is backlogged) |
| 9 | ServeFlow(f); |
| 10 | else idle_sched( ); |
| 11 | p[i]= (p[i]+1) % 2ⁱ; |
| 12 | } |
| 13 | pw = (pw+1)%(2^{k}−1) |
| 14 | } |
| 15 | } |
| } | |

In the scheduling system, a special flow with id 0 is reserved for the best-effort traffic, which does not have bandwidth requirement. The un-allocated bandwidths are all ‘allocated’ to this flow 0. A simple way to implement idle_sched is to assign this scheduling opportunity to flow 0.

When the packets are of the same fixed size, ServeFlow in schedule is simple: it just de-queue a packet from the queue and transmit it via the output link. When the packets are of variable size, a quota is introduced for each flow. Each time a flow is served, its quota is increased by Lₘₐₓ, where Lₘₐₓ is the maximum packet size of the output link. When a flow transmits a packet, its quota is decreased by the size of the transmitted packet. The scheduling system also maintains a global quota, gquota, which is the sum of the quota values of all the flows. ServeFlow for variable packet size is depicted in TABLE 7. In ServeFlow, flow f is served if the size of the packet in the queue head is no larger than its quota (lines 3-6). After that, flow f checks if it can borrow quota from gquota. Flow f is served if the size of the packet in the queue head is no larger than gquota and the quota borrowed is less than Lₘₐₓ (lines 8-12). Lines 1 and 7 are to maintain the value of gquota. Line 2 is to update the quota of flow f.

TABLE 7
Procedure to serve a flow when packets are of variable size
ServeFlow (f) {

| | |
|---|---|
| 1 | gquota = gquota − quota_{f}; //quota_{f} is the quota for flow f |
| 2 | quota_{f} += Lₘₐₓ; |
| 3 | while (Lₚ <= quota_{f}){ //Lₚ is the size of the packet in the queue head |
| 4 | p = dequeue(f); send(p); // p is the packet in the queue head |
| 5 | quota_{f} = quota_{f}−Lₚ; |
| 6 | } |
| 7 | gquota = gquota + quota_{f}; |
| 8 | while (Lₚ <= gquota and quota_{f}−Lₚ > −Lₘₐₓ) { |
| 9 | p = dequeue(f); send(p); |
| 10 | gquota = gquota −Lₚ; |
| 11 | quota_{f}= quota_{f}−Lₚ; |
| 12 | } |
| } | |

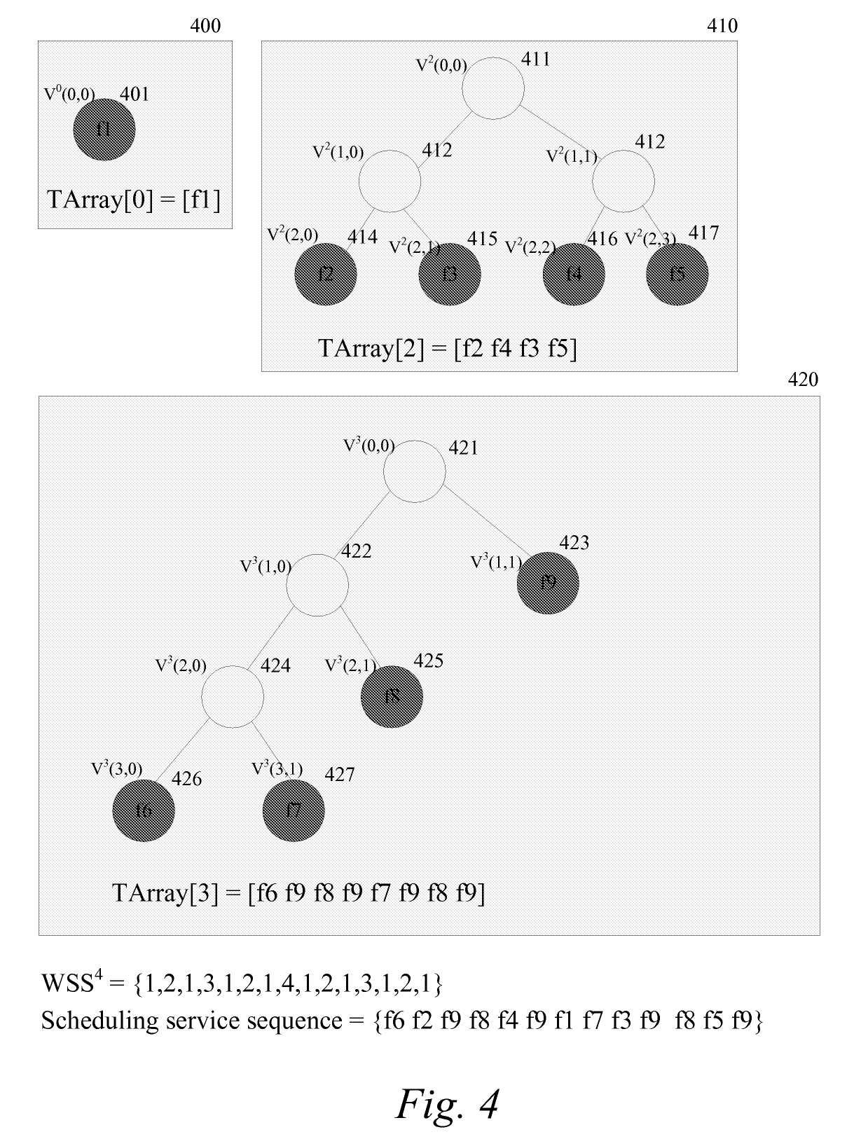

In FIG. 4, we use an example to illustrate how flows are added into the system and how schedule works. In this example, the bandwidth of the output link is C=13. The diagonal terms of the Square Weight Matrix are a₃=a₂=a₀=1 and a₁=0. The corresponding Weight Spread Sequence is of order 4, and the sequence is WSS⁴={1,2,1,3,1,2,1,4,1,2,1,3,1,2,1}. The system accepts nine flows with f1-f7 have rate 1, f8 has rate 2, and f9 has rate 4. When the first flow f1 is accepted into the system, based on the flow_add procedure, V⁰(0,0) 401 is allocated to f1, and the corresponding term of TArray[0] is updated, that is, TArray[0][0]=f1. When f2 is added, V²(2,0) 414 is allocated to f2 and TArray[2][0] is set to f2. Similarly, V²(2,1) 415 is allocated to f3 and TArray[2][2]=f2, V²(2,2) 416 is allocated to f4 and TArray[2][1]=f4, V²(2,3) 417 is allocated to f5 and TArray[2][3]=f5, V³(3,0) 426 is allocated to f6 and TArray[3][0]=f6, V³(3,1) 427 is allocated to f7 and TArray[3][4]=f7, V³(2,1) 425 is allocated to f8 and TArray[3][2]=TArray[3][6]=f8, and V³(1,1) 423 is allocated to f9 and TArray[3][1]=TArray[3][3]=TArray[3][5]=TArray[3][7]=f9. The Trees and the TArrays after all the flows are added are depicted in FIG. 4.

The scheduling operation performed by schedule is to use the WSS sequence to scan the Square Weight Matrix and to use the TArrays to scan the Weighted Binary Trees. In FIG. 4, the first term of WSS is 1, then according to schedule (line 5 of TABLE 6), a₃ of the Square Weight Matrix is chosen. Since a₃ is not zero, then the current term of TArray[3] is chosen, since p[3]=0, TArray[3][0] is chosen, and f6 is therefore served. After that, the pointers pw and p[3] are all advanced by one-step. The current WSS term becomes 2, a₂ of the Square Weight Matrix is then chosen. Since a₂ is not zero, then the current term of TArray[2], TArray[2][0], is chosen, f2 is therefore served. After that, pw and p[2] are advanced by one step. The next term of WSS is 1 again, and TArray[3] is chosen, the current term of TArray[3] is TArray[3][1], and f9 is served, and pw and p[3] are advanced by one step. The next term of WSS is then 3, and a₁ is chosen, since a₁ is zero, schedule therefore does not serve any flow, and just advances the pw by one step. By following the schedule procedure, the first round (13 steps) service sequence can be generated: f6 f2 f9 f8 f4 f9 f1 f7 f3 f9 f8 f5 f9.

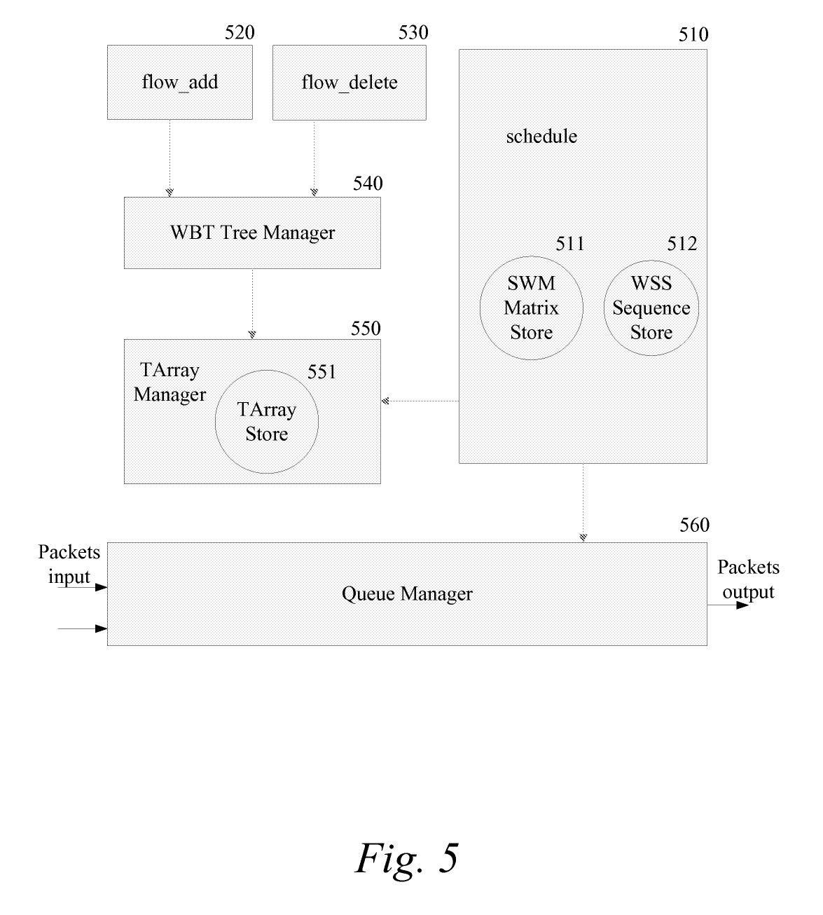

FIG. 5 depicts one embodiment of the implementation structure of the scheduling system. Schedule 510 decides which flow to serve. It contains a SWM Matrix Store 511, which stores the Square Weight Matrix, and a WSS Sequence Store 512, which stores the WSS sequence. WBT Tree Manager 540 manages the Weighted Binary Trees, it allocates new nodes for an incoming flow when flow_add 520 is invoked, and frees allocated nodes when flow_delete 530 is invoked to remove a flow. TArray Manager 550 manages values contained in the TArrays, which are stored in the TArray Store 551. The Queue Manager 560 is to manage packets from different flows, it buffers the incoming packets to their corresponding queues and de-queue packets for transmission on behalf of schedule 510.

In one embodiment, flow_add, flow_delete, and schedule can be three independent processes. When flow_add or flow_delete updates the terms of TArray[i], it can start to update the term that is the first one next to the term points by p[i]. This way, flow_add and flow_delete can be carried out simultaneously together with schedule, and schedule does not need to wait for the TArray update operations.

The updated UpdateTArray is show in TABLE 8. One only need to substitute the UpdateTArray to the procedure in TABLE 8 to get the new flow_add and flow_delete procedures.

TABLE 8

| UpdateTArray2(node, fid) { | |
|---|---|
| 1 | n = node.n; |
| 2 | h = node.h; |
| 3 | i = node.i; |
| 4 | ri = binary_reversal(i * 2^{(n-h)}); |
| 5 | y = ceil ((p[n]−ri) / 2^{h}); |
| 6 | x = (ri + y * 2^{h}) % 2ⁿ; |
| 7 | for (int j=0; i<2^{(n-h)}; j++) { |
| 8 | index = (x+j*2^{h}) % 2ⁿ; |
| 9 | TArray[n][index]=fid; |
| 10 | } |
| } | |

The scheduling system may face the bandwidth fragmentation problem as illustrated by the example as follows. Suppose the bandwidth of the output link is 2ⁿ. At the beginning, there are 2ⁿ flows each with rate 1. The flows are numbered from 1 to 2ⁿ, and the nodes of the Weighted Binary Tree that are allocated to these flows are Vⁿ(n,0), Vⁿ(n,1), . . . , Vⁿ(n,2ⁿ−1), respectively. After some time, the even numbered flows are left and the allocated nodes are freed. Then a flow with rate 2 comes. The system will not be able to allocate a node with weight 2 to this flow, even when half of the bandwidth is free.

```
TABLE 9
The shaping procedure
marking( ) {
    while (1) {
        for (each linked list list[w])
            if (exists two idle nodes Vⁿ(n−w, i) and V^{m}(m−w,j))
                add swapping flags to Vⁿ(n−w, i′) and V^{m}(m−w,j′);
    }
}
swapping ( ) {
    if (Vⁿ(n−w, i′) is served first) {
        list[w].remove(V^{m}(m−w, j));
        UpdateTArray( V^{m}(m−w, j), f);
        UpdateTArray( Vⁿ(n−w, i′), 0);
        FreeNode(Vⁿ(n−w, i′));
    }else {
        list[w].remove(Vⁿ(n−w, i));
        UpdateTArray( Vⁿ(n−w, i), g);
        UpdateTArray( V^{m}(n−w, j′), 0);
        FreeNode(V^{m}(n−w, j′));
    }
}
```

In order to solve this bandwidth fragmentation problem, we introduce a background shaping process to adjust the shape of the Weighted Binary Trees. shaping works by swapping the positions of a free node and an allocated node. The detailed procedure is depicted in TABLE 9. In TABLE 9, Vⁿ(n-w, i) and V^{m}(m-w,j) are two free nodes, and Vⁿ(n-w, i′) and Vⁿ(m-w,j′) are their siblings, respectively. Vⁿ(n-w, i′) is allocated to flow f and V^{m}(m-w,j′) is allocated to flow g. By swapping the positions of Vⁿ(n-w, i) and Vⁿ(m-w,j′) (or the positions of V^{m}(m-w,j) and Vⁿ(n-w, i′)), the two free nodes become siblings and can then be merged together. In order to make the swapping operation not affect the service received by a flow, the shaping process is divided into two parts. A marking to add two swapping flags to the sibling nodes of two free nodes, and a swapping operation that is triggered after one of the sibling nodes has been served by schedule.

One skilled in the art will appreciate that although specific embodiments of the scheduling system have been described herein for purposes of illustration, various modifications may be made without deviating from the spirit and scope of the invention. For example, if the granularity for bandwidth allocation is larger than 1 bit/second, the value used to generate the Square Weight Matrix should be C/granularity. When the granularity is 1024 bit/second instead of 1 bit/second, the resulting Square Weight Matrix will be much smaller, and the space needed to hold the WSS sequence and the TArrays would also be greatly reduced. Another example is that though the invention is on packet scheduling in computer networks, the invention can be applied to scenarios where resources are proportionally shared, such as process and thread scheduling in the operating systems.

I/We claim:

1. A method in a network device for scheduling packets, the method comprising:
Providing a Square Weight Matrix to express the bandwidth of the communication link;
Providing several Weighted Binary Trees to express the non-zero terms of the Square Weight Matrix;
Using a Weight Spread Sequence to spread the Square Weight Matrix;
Using a Time-Slot Array and a binary reversal operation to represents nodes of the Weighted Binary Tree into the Time-Slot Array;
A procedure to add a new flow into the Weighted Binary Trees by representing the rate of the flow into its binary form;
A procedure to remove an old flow;
A procedure to decide which flow to serve when the previous flow has been served;
A procedure to adjust the shape of the Weighted Binary Trees; and
A procedure to serve flows with variable packet size.

2. The method of claim 1 wherein the Square Weight Matrix is composed from the binary coefficients of the bandwidth of the communication link. The diagonal terms of the Square Weight Matrix are corresponding binary coefficients of the output bandwidth, and the other terms of the Square Weight Matrix are all zero.

3. The method of claim 1 wherein each non-zero term of the Square Weight Matrix is expressed by a Weighted Binary Trees, the maximum depth of the Weighted Binary Tree is determined by the weight of the corresponding term in the Square Weight Matrix. When the weight of the term is 2ⁿ, the depth of the Weighted Binary Tree is at most (n+1).

4. The method of claim 1 wherein a set of Weight Spread Sequences (WSS) is recursively generated. The first sequence is WSS¹={1}, the second WSS² is {1,2,1}, the third WSS³ is {1,2,1,3,1,2,1}, and the nth WSSⁿ is {WSSⁿ⁻¹, n WSSⁿ⁻¹}.

5. The method of claim 4 wherein the order of the Weight Spread Sequence is decided by the logarithm value of the bandwidth of the communication link.

6. The method of claim 1 wherein a Weighted Binary Tree is spread by a Time-Slot Array. The number of terms in the Time-Slot Array is the weight of the Perfect Weighted Binary Tree.

7. The method of claim 6 wherein the indices of the Time-Slot Array terms that corresponds to a Weighted Binary Tree node is generated by using a binary reversal operation.

8. The method of claim 1 wherein when a new flow is admitted, the method first expresses the reserved bandwidth of the flow into binary form, and for each non-zero binary coefficient, the method allocates a node of the same weight from the Weighted Binary Trees. The terms in the Time-Slot Array that corresponds to the allocated nodes are filled with the flow id of the flow.

9. The method of claim 1 wherein when a flow is removed, the nodes that are allocated to the flow in the Weighted Binary Trees are de-allocated, and the corresponding terms in the Time-Slot Arrays are reset accordingly.

10. The method of claim 1 wherein when there are packets in the system, the Weight Spread Sequence is scanned term by term circularly. When the value of the scanned term is i, the (k-i)th Time-Slot Array is selected, where k is the order of the Weight Spread Sequence. The current term of this Time-Slot Array is selected, and the flow that occupies the current term of this Time-Slot Array is then served. After that, the pointers that point to the current positions of the Weight Spread Sequence and the selected Time-Slot Array are advanced by one-step.

11. The method of claim 1 wherein when there are two free Weighted Binary Tree nodes, a node swapping procedure is invoked, so that the free nodes becomes siblings and then these two free nodes are merged to their parent node.

12. The method of claim1 wherein when packets are of variable size, each flow is associated with a quota value to record its unused bytes, and a global quota is maintained to memorize the sum of quota of all flows.

13. A system for scheduling packets of a communication link where flows from different applications have different bandwidth requirements, comprising:
a Queue Manager that manages received packets from different flows, packets are mapped to different queues based on the information carried in their packet header, each queue is associated with a reserved bandwidth;
a Square Weight Matrix store that stores the Square Weight Matrix which is generated from the bandwidth of the communication link;
a Weight Spread Sequence store that stores the Weight Spread Sequence whose order is decided by the bandwidth of the communication link;
a Tree Manager that stores and manages the set of Weighted Binary Trees, the number of Weighted Binary Trees is decided by the number of non-zero terms in the Square Weight Matrix;
a Time-Slot Array Manager that stores and manages the set of Time-Slot Arrays;
a flow_add process that admits a new flow;
a flow_delete process that removes a flow;
a scheduler process that decides which flow to serve when the communication link has finished serve the previous flow.

14. A system of claim 13 wherein when flow_add adds a new flow in the system, the Queue Manager allocates a queue for the flow, the Tree Manager allocates nodes for the flow, and the Time-Slot Array Manager fills the id of the new flow into the corresponding terms of the Time-Slot Arrays.

15. A system of claim 13 wherein when flow_delete removes a flow from the system, the Queue Manager frees the queue for that flow, the Tree Manager will de-allocates the nodes for the flow, and the Time-Slot Array Manager resets the terms that once allocated to that flow.

16. A system of claim 13 including a pointer that points to the current scanned position of the Weight Spread Sequence, the pointer is initialized to point to the first term of the Weight Spread Sequence.

17. A system of claim 13 including a pointer for each Time-Slot Array, the pointer is initialized to point to the first term of the Time-Slot Array.

18. A system of claim 13 wherein when the scheduler finishes serving a flow, the pointers of the Weight Spread Sequence and the selected Time-Slot Array are advanced by one-step if they are not pointed to the last term; otherwise, they are reset to point to the first term.

19. A system of claim 13 wherein when there is no packet in the system, the scheduler enters idle state and the pointers of the Weight Spread Sequence and Time-Slot Arrays are reset to their initial positions.
